(19) United States
(12) Patent Application Publication
(10) Pub. No.: US 2017/0274809 A1
(43) Pub. Date: Sep. 28, 2017

(54) Winch Mounting System

(71) Applicant: Robert C. Robinson, Clover, SC (US)

(72) Inventor: Robert C. Robinson, Clover, SC (US)

(21) Appl. No.: 15/079,876

(22) Filed: Mar. 24, 2016

(51) Int. Cl. B60P 1/00; B66D 1/60; B66D 3/00; B65G 67/04; B66D 1/12

(52) U.S. Cl. CPC B60P 1/00; B65G 67/04; B66D 1/12; B66D 3/006; B66D 1/60

(57) ABSTRACT

A winch mounting system includes a truck that has a bed. A mounting unit is removably coupled to the bed. The mounting unit has a slidably adjustable width such that the mounting unit accommodates a variety of widths of the bed. A winch is selectively coupled to the mounting unit such that the winch is positioned in the bed. A button is coupled to the mounting member and the button may be manipulated. The button is electrically coupled to the truck. The button is electrically coupled to the winch such that the button turns the winch on and off.

### BACKGROUND OF THE DISCLOSURE

### Field of the Disclosure

The disclosure relates to mounting devices and more particularly pertains to a new mounting device for removably coupling a winch to a bed of a truck.

### SUMMARY OF THE DISCLOSURE

An embodiment of the disclosure meets the needs presented above by generally comprising a truck that has a bed. A mounting unit is removably coupled to the bed. The mounting unit has a slidably adjustable width such that the mounting unit accommodates a variety of widths of the bed. A winch is selectively coupled to the mounting unit such that the winch is positioned in the bed. A button is coupled to the mounting member and the button may be manipulated. The button is electrically coupled to the truck. The button is electrically coupled to the winch such that the button turns the winch on and off.

There has thus been outlined, rather broadly, the more important features of the disclosure in order that the detailed description thereof that follows may be better understood, and in order that the present contribution to the art may be better appreciated. There are additional features of the disclosure that will be described hereinafter and which will form the subject matter of the claims appended hereto.

The objects of the disclosure, along with the various features of novelty which characterize the disclosure, are pointed out with particularity in the claims annexed to and forming a part of this disclosure.

### BRIEF DESCRIPTION OF THE DRAWINGS

The disclosure will be better understood and objects other than those set forth above will become apparent when consideration is given to the following detailed description thereof. Such description makes reference to the annexed drawings wherein:

FIG. 1 is a top perspective view of a winch mounting system according to an embodiment of the disclosure.

FIG. 2 is a top view of an embodiment of the disclosure.

FIG. 3 is a front view of an embodiment of the disclosure.

FIG. 4 is a cross sectional view taken along line 4-4 of FIG. 2 of an embodiment of the disclosure.

FIG. 5 is a perspective in-use view of an embodiment of the disclosure.

### DESCRIPTION OF THE PREFERRED EMBODIMENT

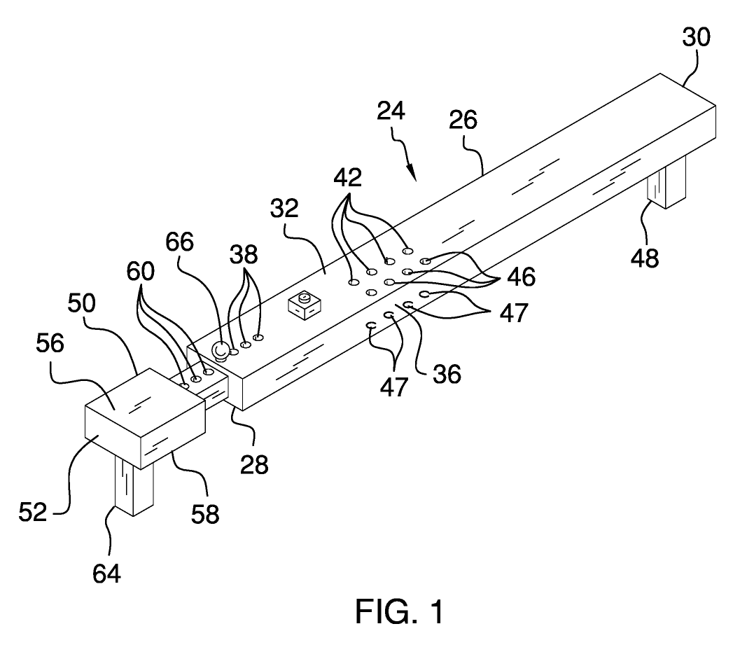

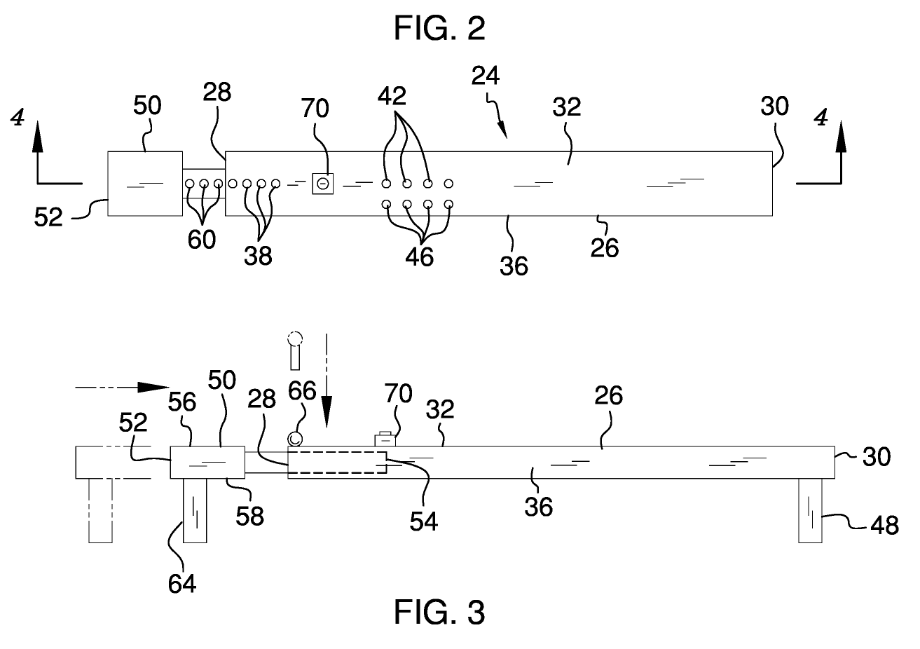

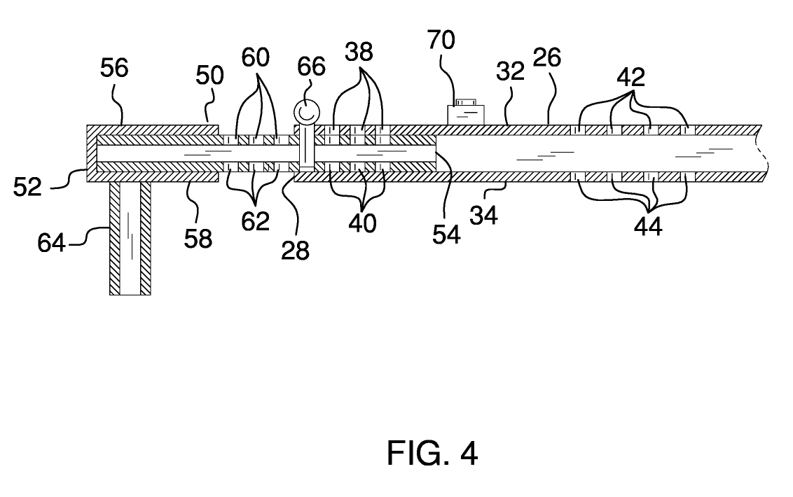

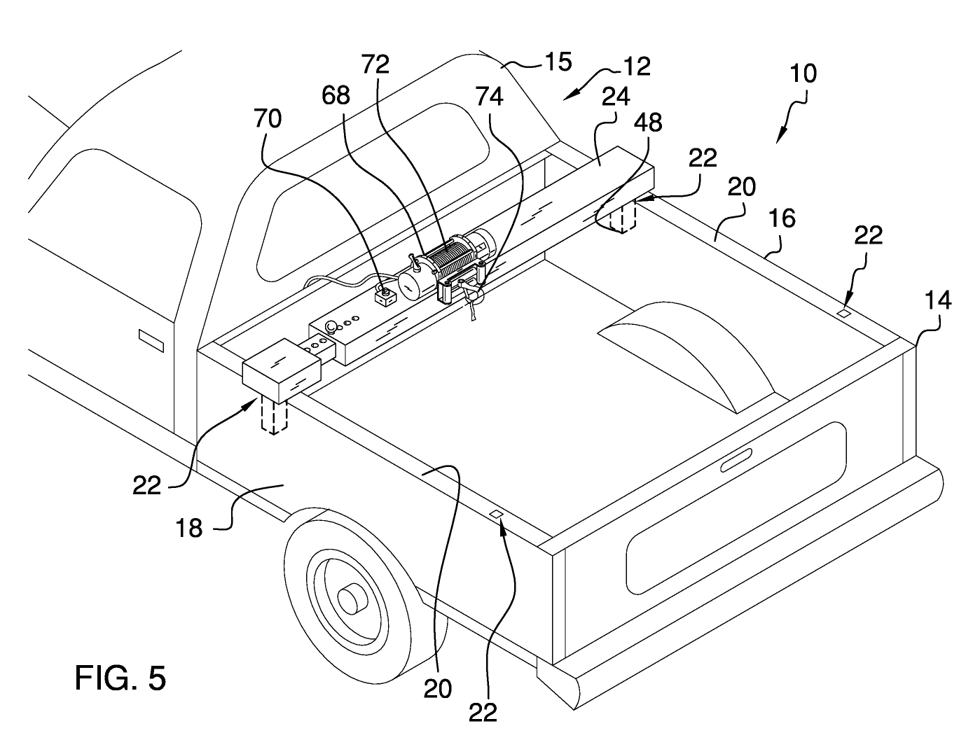

With reference now to the drawings, and in particular to FIGS. 1 through 5 thereof, a new mounting device embodying the principles and concepts of an embodiment of the disclosure and generally designated by the reference numeral 10 will be described.

As best illustrated in FIGS. 1 through 5, the winch mounting system 10 generally comprises a truck 12 that has a bed 14 and a cab 15. The bed 14 has a first lateral wall 16 and a second lateral wall 18. Each of the first lateral wall 16 and the second lateral wall 18 has a top side 20. The top side 20 corresponding to each of the first lateral wall 16 and the second lateral wall 18 has at least one well 22 extending downwardly therein. The truck 12 may comprise a pickup truck or the like.

A mounting unit 24 is provided and the mounting unit 24 is removably coupled to the bed 14. The mounting unit 24 has a slidably adjustable width. Thus, the mounting unit 24 accommodates a variety of widths of the bed 14. The mounting unit 24 comprises a first member 26 that has a first end 28, a second end 30, a top side 32, a bottom side 34 and a front side 36. The first end 28 is open and the first member 26 is substantially hollow.

The top side 32 has a plurality of apertures 38 extending therethrough. The apertures 38 are spaced apart from each other and are distributed from the first end 28 toward the second end 30. The bottom side 34 has a complementary set of apertures 40 with respect to the apertures 38 on the top side 32. Each of the apertures 40 on the bottom side is aligned with a corresponding one of the apertures 38 on the top side 32.

The top side 32 has a first set of holes 42 extending therethrough. The first set of holes 42 is spaced apart from each other and distributed along the top side 32. Each of the first set of holes 42 is centrally positioned on the top side 32. The bottom side 34 of the first member 26 has a complementary set of first set of holes 44 with respect to the first set of holes 42 on the top side 32.

The top side 32 has a second set of holes 46 extending therethrough. Each of the second set of holes 46 is spaced apart from each other. Moreover, the second set of holes 46 is distributed along the top side 32. The second set of holes 46 is aligned with the first set of holes 42. The second set of holes 46 is positioned between the first set of holes and the front side. Additionally, the bottom side 34 has a complementary set of second set of holes 47 with respect to the second set of holes 46 on the top side 32.

A first post 48 is coupled to and extends downwardly from the bottom side 34 of the first member 26. The first post 48 is positioned adjacent to the second end 28 of the first member 26. The first post 48 is selectively inserted into the at least one well 22 corresponding to the first lateral side 16 of the bed 14. Thus, the first member 26 is removably coupled to the bed 14.

The mounting unit 24 further includes s second member 50. The second member 50 has a primary end 52, a secondary end 54, an upper side 56 and a lower side 58. The first end 28 of the first member 26 slidably receives the secondary end 54. Thus, the second member 50 is slidably coupled to the first member 26. The upper side 56 has a plurality of openings 60 extending therethrough. The openings 60 are spaced apart from each other and are distributed from the secondary end 54 toward the primary end 52. The lower side 58 of the second member 50 has a complementary plurality of openings 62 with respect to the openings 60 on the upper side 56.

A second post 64 is coupled to and extends downwardly from the lower side 58 of the second member 50. The second post 64 is positioned adjacent to the primary end 52. The second post 64 is selectively inserted into the at least one well 22 corresponding to the second lateral side 18 of the bed 14. Thus, the second member 50 is removably coupled to the bed 14. A pin 66 is selectively inserted through a selected one of the apertures 38 in the first member 26 and a selected one of the openings 60 in the second member 50. Thus, the mounting unit 24 is retained at a selected width.

A winch 68 is selectively coupled to the mounting unit 24 such that the winch 68 is positioned in the bed 14. The winch 68 engages selected ones of the first set of holes 42 and selected ones of the second set of holes 46. Thus, the winch 68 is removably coupled to the first member 26. The winch 68 may be an electric cable winch or the like. The winch 68 may be coupled to the mounting unit 24 with bolts or the like.

A button 70 is coupled to the mounting unit 24 and the button 70 may be manipulated. The button 70 is electrically coupled to the truck 12. The button 70 is electrically coupled to the winch 68 such that the button 70 turns the winch 68 on and off. The winch 68 includes a cable 72 and a hook 74.

In use, mounting unit 24 is coupled to the bed 14. The mounting unit 24 may be positioned adjacent to the cab 15. The winch 68 is coupled the mounting unit 24. The cable 72 is selectively played outwardly from the winch 68 and the hook 74 is coupled to an object. The button 70 is manipulated to turn the winch 68 on. Thus, the winch 68 draws the object into the bed 14. The button 70 is manipulated to turn the winch 68 off when the object is positioned in the bed 14.

With respect to the above description then, it is to be realized that the optimum dimensional relationships for the parts of an embodiment enabled by the disclosure, to include variations in size, materials, shape, form, function and manner of operation, system and use, are deemed readily apparent and obvious to one skilled in the art, and all equivalent relationships to those illustrated in the drawings and described in the specification are intended to be encompassed by an embodiment of the disclosure.

Therefore, the foregoing is considered as illustrative only of the principles of the disclosure. Further, since numerous modifications and changes will readily occur to those skilled in the art, it is not desired to limit the disclosure to the exact construction and operation shown and described, and accordingly, all suitable modifications and equivalents may be resorted to, falling within the scope of the disclosure. In this patent document, the word “comprising” is used in its non-limiting sense to mean that items following the word are included, but items not specifically mentioned are not excluded. A reference to an element by the indefinite article “a” does not exclude the possibility that more than one of the element is present, unless the context clearly requires that there be only one of the elements.

1. A winch mounting system configured to removably mount a winch in a bed of a truck, said system comprising:
a truck having a bed;
a mounting unit being removably coupled to said bed, said mounting unit having a slidably adjustable width such that said mounting unit accommodates a variety of widths of said bed;
a winch being selectively coupled to said mounting unit such that said winch is positioned in said bed; and
a button being coupled to and positioned directly on said mounting unit, said button being electrically coupled to said truck, said button being electrically coupled to said winch such that said button turns said winch on and off.

2. The system according to claim 1, wherein said mounting unit comprises:
a first member having a first end, a second end, a top side, a bottom side and a front side, said first end being open, said first member being substantially hollow, said top side having a plurality of apertures extending therethrough, said apertures being spaced apart from each other and being distributed from said first end toward said second end;
said top side having a first set of holes extending therethrough, said first set of holes being spaced apart from each other and distributed along said top side, each of said first set of holes being centrally positioned on said top side; and
said top side has a second set of holes extending therethrough, said second set of holes being spaced apart from each other and being distributed along said top side, said second set of holes being aligned with said first set of holes, said second set of holes being positioned between said first set of holes and said front side.

3. The system according to claim 2, further comprising:
said bed having a first lateral wall, said first lateral wall having a top side, said top side having at least one well extending downwardly therein; and
a first post being coupled to and extending downwardly from said bottom side of said first member, said first post being positioned adjacent to said second end of said first member, said first post being selectively inserted into said at least one well corresponding to said first lateral side of said bed.

4. The system according to claim 1, wherein said mounting unit comprises:
a first member having a first end; and
a second member having a primary end, a secondary end, an upper side and a lower side, said first end of said first member slidably receiving said secondary end such that said second member is slidably coupled to said first member, said upper side having a plurality of openings extending therethrough, said openings being spaced apart from each other and being distributed from said secondary end toward said primary end.

5. The system according to claim 4, further comprising:
said bed having a first lateral wall, said first lateral wall having a top side, said top side having at least one well extending downwardly therein, said bed having a second lateral wall, said second lateral wall having a top side, said top side having at least one well extending downwardly therein;
a first post being coupled to and extending downwardly from said bottom side of said first member; and
a second post being coupled to and extending downwardly from said lower side of said second member, said second post being positioned adjacent to said primary end, said second post being selectively inserted into said at least one well corresponding to said second lateral side of said bed.

6. The system according to claim 4, further comprising:
said first member having a plurality of apertures; and
a pin being selectively inserted through a selected one of said apertures in said first member and a selected one of said openings in said second member such that said mounting unit is retained at a selected width.

7. The system according to claim 2, wherein said winch engages selected ones of said first set of holes and selected ones of said second set of holes such that said winch is removably coupled to said first member wherein said winch is configured to selectively urge an object into said bed.

8. A winch mounting system configured to removably mount a winch in a bed of a truck, said system comprising:
a truck having a bed, said bed having a first lateral wall and a second lateral wall, each of said first lateral wall and said second lateral wall having a top side, said top side corresponding to each of said first lateral wall and said second lateral wall having at least one well extending downwardly therein;
a mounting unit being removably coupled to said bed, said mounting unit having a slidably adjustable width such that said mounting unit accommodates a variety of widths of said bed, said mounting unit comprising:
a first member having a first end, a second end, a top side, a bottom side and a front side, said first end being open, said first member being substantially hollow, said top side having a plurality of apertures extending therethrough, said apertures being spaced apart from each other and being distributed from said first end toward said second end, said top side having a first set of holes extending therethrough, said first set of holes being spaced apart from each other and distributed along said top side, each of said first set of holes being centrally positioned on said top side, said top side having a second set of holes extending therethrough, said second set of holes being spaced apart from each other and being distributed along said top side, said second set of holes being aligned with said first set of holes, said second set of holes being positioned between said first set of holes and said front side,
a first post being coupled to and extending downwardly from said bottom side of said first member, said first post being positioned adjacent to said second end of said first member, said first post being selectively inserted into said at least one well corresponding to said first lateral side of said bed,
a second member having a primary end, a secondary end, an upper side and a lower side, said first end of said first member slidably receiving said secondary end such that said second member is slidably coupled to said first member, said upper side having a plurality of openings extending therethrough, said openings being spaced apart from each other and being distributed from said secondary end toward said primary end,
a second post being coupled to and extending downwardly from said lower side of said second member, said second post being positioned adjacent to said primary end, said second post being selectively inserted into said at least one well corresponding to said second lateral side of said bed, and
a pin being selectively inserted through a selected one of said apertures in said first member and a selected one of said openings in said second member such that said mounting unit is retained at a selected width;
a winch being selectively coupled to said mounting unit such that said winch is positioned in said bed, said winch engaging a selected ones of said first set of holes and selected ones of said second set of holes such that said winch is removably coupled to said first member wherein said winch is configured to selectively urge an object into said bed; and
a button being coupled to and positioned directly on top side of said first member of said mounting unit wherein said button is configured to be manipulated, said button being electrically coupled to said truck, said button being electrically coupled to said winch such that said button turns said winch on and off.
